(19) United States
(12) Patent Application Publication
(10) Pub. No.: US 2026/0019940 A1
(43) Pub. Date: Jan. 15, 2026

(54) TIME DOMAIN NETWORK ENERGY SAVING TECHNIQUES

(71) Applicant: NTEL CORPORATION, Santa Clara, CA (US)

(72) Inventors: Toufiqul Islam, Santa Clara, CA (US); Dae Won Lee, Portland, OR (US); Seau S. Lim, Swindon (GB)

(21) Appl. No.: 18/992,870

(22) PCT Filed: Aug. 9, 2023
(86) PCT No.: PCT/US2023/029875

§ 371 Date: Jan. 9, 2025

Related U.S. Application Data
(60) Provisional application No. 63/397,737, filed on Aug. 12, 2022.
(60) Provisional application No. 63/411,549, filed on Sep. 29, 2022.
(60) Provisional application No. 63/422,357, filed on Nov. 3, 2022.

(51) Int. Cl. H04W 52/02; H04W 76/28

(52) U.S. Cl. CPC H04W 52/0206; H04W 76/28

(57) ABSTRACT

An apparatus and system are described for reducing user equipment (UE) power consumption after a 5th generation NodeB (gNB) indicates transition to a power saving mode. Different configurations and rules for the UE to identify and use monitoring or transmission occasions within the PSM active time, as well as modification of UE timers during the PSM, are provided. Discontinuous transmission (DTX) and reception (DRX) configurations are signaled to the UE and contain periodicity, start slot/offset, and on duration, as well as activation of the configurations by downlink control information (DCI). UE reporting and paging based on the configurations are provided when light synchronization system block (SSB) transmission or discovery reference signal transmission is used by the gNB.

### PRIORITY CLAIM

This application claims the benefit of priority to U.S. Provisional Patent Application Ser. No. 63/397,737, filed Aug. 12, 2022, U.S. Provisional Patent Application Ser. No. 63/411,549, filed Sep. 29, 2022, and United States Provisional Patent Application Ser. No. 63/422,357, filed Nov. 3, 2022, each of which is incorporated herein by reference in its entirety.

### BACKGROUND

The use and complexity of next generation (NG) systems, which include 5th generation (5G) and sixth generation (6G) networks among others, has increased due to both an increase in the types of devices user equipment (UEs) using network resources as well as the amount of data and bandwidth being used by various applications, such as video streaming, operating on these UEs. With the vast increase in number and diversity of communication devices, the corresponding network environment has become increasingly complicated. As expected, a number of issues abound with the advent of any new technology, including complexities related to energy savings within such networks.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a 5^{th} generation NodeB (gNB) discontinuous transmission (DTX)/discontinuous reception (DRX) operation cycle with UE DRX cycle in accordance with some embodiments.

FIG. 4 illustrates a UE monitoring paging occasions (POs) in accordance with some embodiments.

FIG. 5 illustrates multiple configuration/rules to identify paging frames in accordance with some embodiments.

FIG. 6A illustrates a paging frame and paging occasion slots in accordance with some embodiments.

FIG. 6B illustrates reduced paging frame density and increased paging occasion slots in accordance with some embodiments.

FIG. 6C illustrates grouped paging frames and paging occasion slots in accordance with some embodiments.

FIG. 7 illustrates light Synchronization System Block (SSB) transmission in accordance with some embodiments.

FIG. 8 illustrates a process of selecting a configuration in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

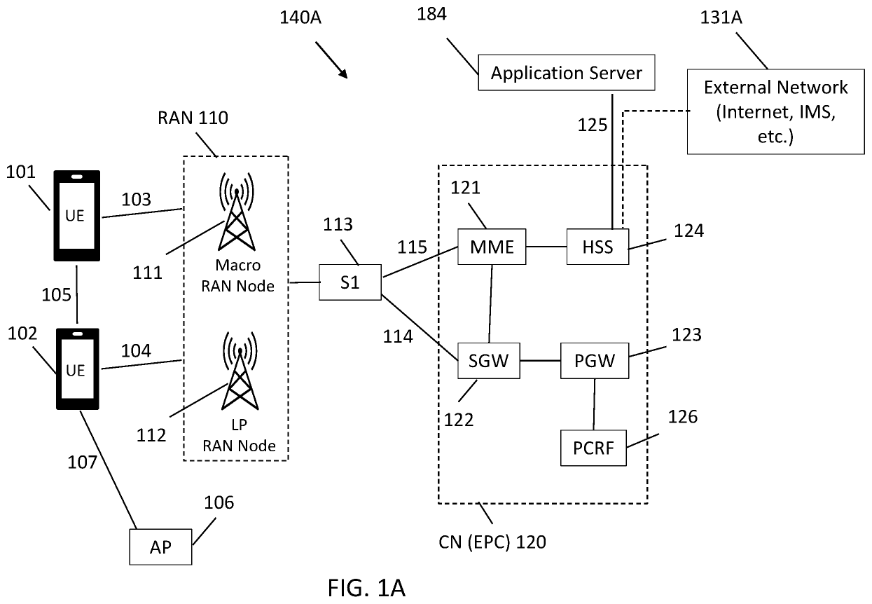

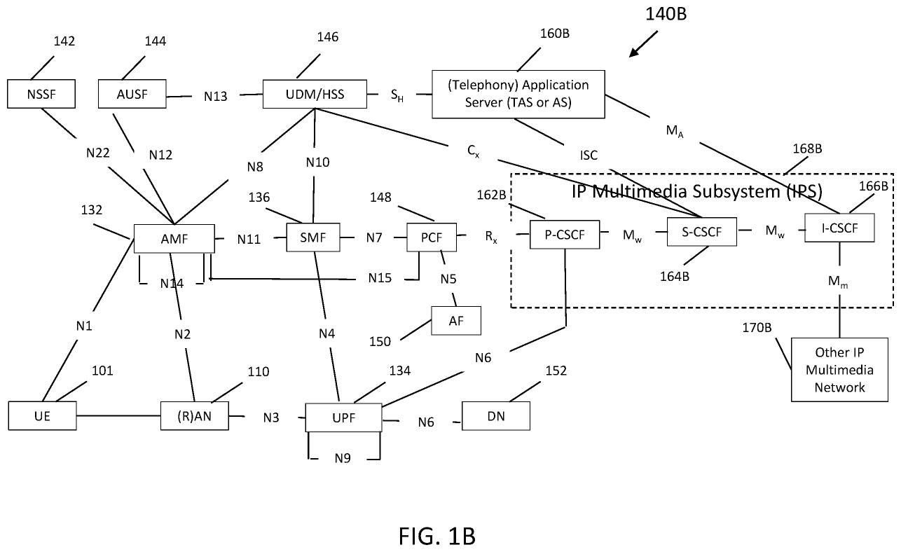

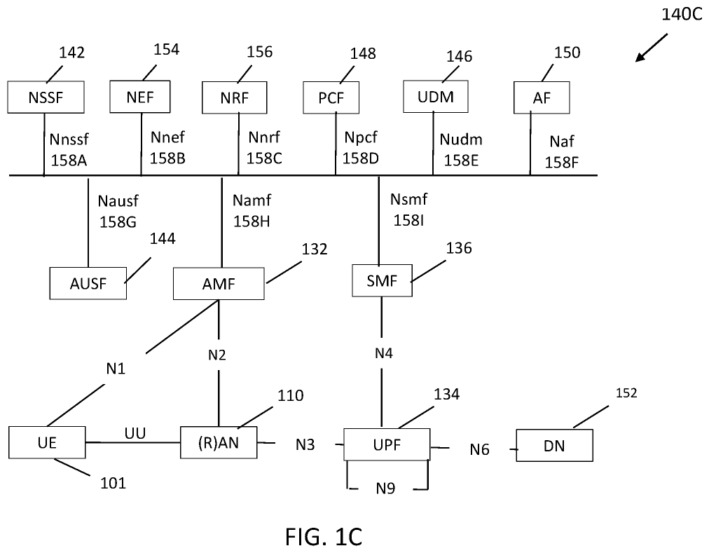

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a primary node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

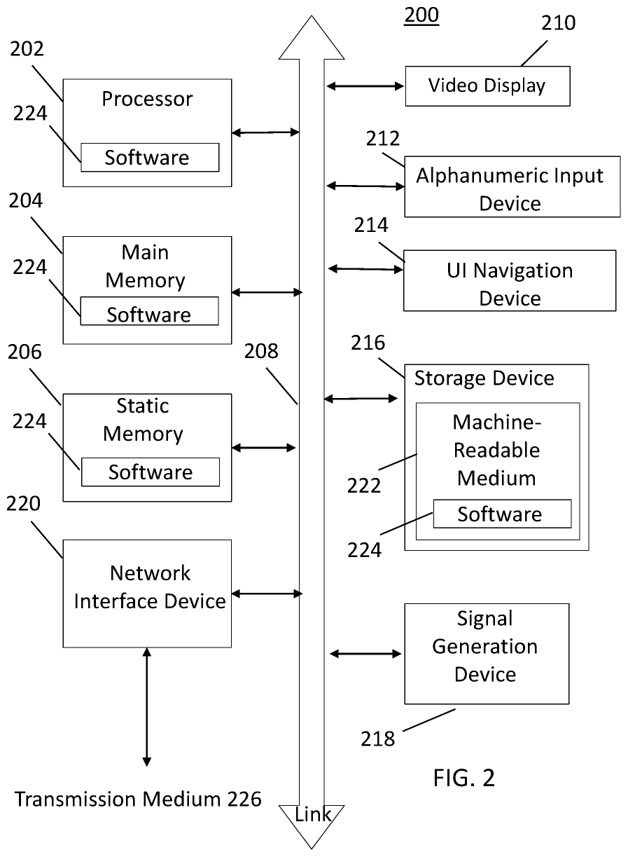

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5th generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth (r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA =Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, energy consumption is a major contributor to network operating expenditure (OPEX). The implementation of energy-efficient equipment and techniques can bring significant benefits by helping operators to deal with unpredictable fuel prices and conserve power. Compared with a 4G network, a 5G system has a larger bandwidth, an increased number of transmit/receive (TX/RX) antennas/panels, and a higher deployment density for improvement of system performance and user experience. At this point, different vendors may implement proprietary solutions to improve or optimize their network energy consumption. However, such techniques may be limited by lack of feedback from the UE or better gNB-UE coordination so that more information may be available at the gNB to ensure more optimized network energy saving. Standardized solutions, such as feedback from the UE or control signaling from the gNB in support of network energy saving may close this gap. One potential enabler for network energy saving is increasing longer sleep opportunities for the base station. In other words, the base station or gNB may only be active for a certain time over a cycle, and transmission to/from the UE may be made when the gNB is active. As such, different time domain network energy saving techniques and procedures related to the gNB entering a power saving mode and corresponding UE behaviors are discussed herein.

Different techniques are discussed regarding how a UE may be able to identify monitoring or transmission occasions after the gNB indicates transition to power saving mode. Different configurations and rules for the UE to identify monitoring or transmission occasions within the active time of the gNB are also discussed, as are methods for the UE reporting to the gNB when a light synchronization system block (SSB) or discovery reference signal is detected.

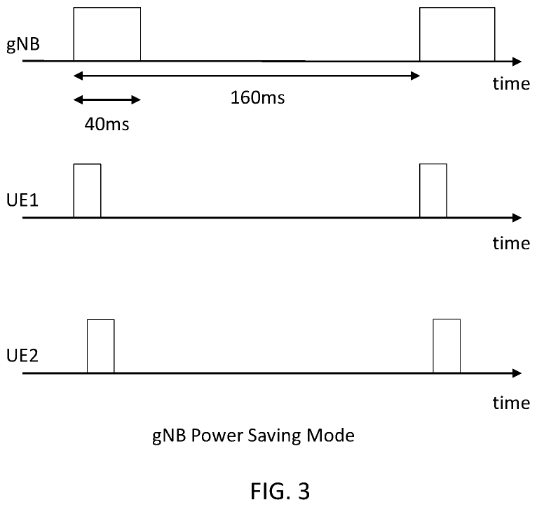

Typical gNB operation may serve different loading conditions, such as a low, moderate, or high load (which may be defined by the operator), and correspondingly system resource utilization may vary. Under low load conditions, resource utilization is expected to be low. As a result, it may be possible that a gNB has higher chances of inactivity, i.e., no transmission or reception may occur for a certain amount of time, leading to the gNB more frequently residing in a non-active state (which may also be referred to as an idle mode for the gNB, and may have different characteristics as the UE idle mode). To increase network energy saving even further, the gNB may transition to DTX/DRX transmission mode or power saving mode and transmissions to/from the UEs in the serving cell may be made to align within the active window of the gNB DTX/DRX operation cycle. FIG. 3 illustrates a gNB DTX/DRX operation cycle with UE DRX cycle in accordance with some embodiments. In particular, the UE DRX cycle aligns with the gNB operation cycle, where the UE and gNB active times overlap.

In this case, the gNB may configure the channel state information reference signal (CSI-RS), SSB, or physical downlink control channel (PDCCH) with a periodicity aligned with the DTX/DRX cycle with transmissions within the DTX/DRX ON period. Correspondingly, the UE may also discontinuously receive the corresponding CSI-RS, SSB, or PDCCH. The alignment may also apply to other downlink (DL) transmissions such as Semi-Persistent Scheduling (SPS) physical downlink shared channel (PDSCH), dynamic grant (DG) PDSCH, and uplink (UL) transmissions such as sounding reference signals (SRS), scheduling request (SR)/physical uplink control channel (PUCCH), configured grant (CG) and/or DG physical uplink shared channel (PUSCH). In this regard, the gNB may signal the DTX/DRX configuration to the UE(s) in the serving cell. This may apply to UEs following Rel-18 or later specifications. For legacy UEs, i.e., UEs following earlier specifications, such a configuration indication may not be possible.

When the gNB DTX/DRX configuration is active or after the gNB has indicated a transition to a DTX/DRX mode or power saving mode, the UE identifies occasions for reception (transmission) of different signal/channels from (to) the network, such as CSI-RS, tracking reference signal (TRS), SSB, or PDCCH reception from the network or SRS, CG-PUSCH transmission. Procedures for the UE to identify the occasions of signal/channel transmission/reception due to DTX/DRX mode at the gNB are also described. The following embodiments may be applicable to UEs in connected mode, idle mode, or inactive mode. Note that the DTX/DRX mode can also be referred to as the power saving mode (PSM) or network energy saving (NES) mode or state. The DTX/DRX mode may be applicable at each cell at the gNB or across multiple cells at the gNB. It is understood that DTX/DRX embodiments below are inclusive of both a cell- and gNB-level DTX/DRX scenario configuration.

In one embodiment, when the gNB indicates to the UE regarding the gNB transition to DTX/DRX mode or PSM, the UE identifies the valid DL monitoring occasions and/or UL transmission occasions that overlap with the active time of the gNB DTX/DRX mode. Here, the monitoring or transmission occasions may be indicated to the UE by system information and/or identified by the UE based on the specification. In one example, the indication may also be provided to the UE by dedicated radio resource control (RRC) signaling, which may be UE specific or group-common. This is referred to as a first configuration or set of rules to determine the occasions. Out of these monitoring or transmission occasions, a set of occasions is identified to be valid depending on overlap with the gNB active time. In one example, the gNB DTX/DRX mode implies that the gNB is only active periodically according to a cycle, and the active time includes a predetermined duration in every cycle where the gNB may transmit to and/or expect to receive a transmission from the UE.

In one option, the active time or gNB ON duration may be identified by the UE based on one or more of: start offset of active time with respect to a reference point, duration, cycle length or periodicity, number of cycles that the gNB stays on the DTX/DRX mode (until another trigger causes the gNB to exit the DTX/DRX mode). The parameters related to identification of the gNB active time, i.e., parameters related to the DTX/DRX mode at the gNB may be signaled to the UE(s) by broadcast signaling, such as by system information or by downlink control information (DCI).

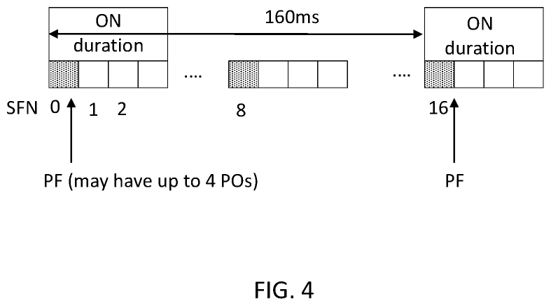

In one example, the UE is not required to monitor the occasions or transmit on the occasions that fall outside the gNB active time. FIG. 4 illustrates a UE monitoring paging occasions (PO) in accordance with some embodiments. The UE may only monitor POs that reside within the ON duration of the gNB DTX/DRX cycle. In FIG. 4, paging occasions, if any, existing outside the gNB active time may be skipped by the UE, thereby allowing the UE to save power. A DTX/DRX cycle length of 160 msec is assumed, whereas the ON duration occupies 4 frames, or 40 msec. If the paging DRX cycle length is T=32 frames and there are 4 paging frames (PF) (that is, the number of PFs, N, is selected as T/8) within a paging cycle, such as at SFN # 0, SFN #8, SFN #16, SFN #24, the UE may skip PDCCH monitoring for receiving paging information in paging occasions (POs) in the PFs that are in SFN #8 and SFN #24 as they fall outside the active time or ON duration of the gNB DTX/DRX cycle. The indices of the SFN assumed for the PFs here are examples only and in practice, the exact SFN numbers may also depend on the UE ID. However, a gap between consecutive PFs is expected to be an integer K>1, if the number of PFs within a paging DRX cycle is N=T/K. In this example, K=8.

Note that the paging DRX cycle is different from the gNB DTX/DRX cycle or operation mode and may be configured separately.

In one example, UEs that have PFs and POs located outside the ON duration may recalculate the PF and PO based on what is available or overlapping with the ON duration or active time of the gNB. In one option, UEs that originally have PFs in SFN #8 and SFN #24 may be instead reassigned to SFN #0 and/or SFN #16. In such case, N is effectively reduced to 2 from 4. Here, it is assumed that offset of the ON duration and paging cycle are aligned.

Similar examples may be applicable for other signal/channel transmissions occasions outside the ON duration or active time, such as PDCCH monitoring for receiving system information, PDCCH monitoring for receiving a paging early indication, TRS, SSB occasions etc. It is expected that the gNB may align the ON duration/active time to critical signal/channel transmission periodicity. For example, in FIG. 4, the gNB may set the SSB transmission periodicity to 160 msec, the same as the DTX/DRX cycle length, and may enter sleep mode after expiry of the ON duration of 40 msec, i.e., 4 frames. In one example, a UE configured with an SSB reception of 20 msec monitors the SSB that lies in the ON-Duration of the gNB when the gNB transitions to the DTX/DRX mode.

In another embodiment, when the gNB indicates to the UE regarding the gNB transition to the DTX/DRX mode or PSM, the UE follows a new second configurations or set of rules to identify the valid DL monitoring occasions and/or UL transmission occasions. Here, the new configuration or set of rules to identify occasions may be different or derived from the first configuration or set of rules to identify monitoring or transmission occasions when the gNB is not in the DTX/DRX mode, i.e., in normal (or non-power saving mode) mode of operation. In one example, both the first and second configurations or sets of rules may be simultaneously active, and the UE finds valid occasions within the gNB active time according to both configurations. In another example, second configuration or set of rules replaces the first configuration/rules.

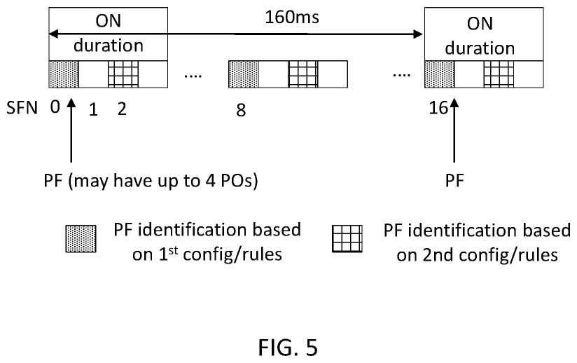

FIG. 5 illustrates multiple configuration/rules to identify paging frames in accordance with some embodiments. In FIG. 5, a second configuration or set of rules used to identify PFs within the ON duration allows for a larger number of groups of UEs to receive paging. Specifically, FIG. 5 shows 2 PFs available for paging reception within the ON duration. Thus, in FIG. 5, an additional configuration/rule is activated, such as for identifying additional SFNs containing PFs within the ON duration when the gNB indicates transition to the DTX/DRX mode. This may be useful if the ON duration is not long enough to include multiple PFs within a paging DRX cycle. If only the first configuration is active, UEs monitoring PFs that fall outside of the ON duration may not have the opportunity to receive paging while the gNB is in the DRX/DTX mode. To this end, when the paging load is such that configuration of a predetermined number of PFs is used within the paging cycle, then one option may be to introduce a new configuration or set of rules so that more PFs may be configured/identified within the ON duration. This may allow for having larger number of groups of UEs to receive paging information while achieving energy saving at the gNB.

Using the configuration example from FIG. 4, there are 2 PFs in SFN #8 and #24 that fall outside the ON duration in a paging DRX cycle. In FIG. 5, the second configuration or set of rules allows maintaining of the same number of total PFs (which is 4) within the paging DRX cycle, where all the PFs now fall within the ON duration and are available for paging reception at the UE(s). In another interpretation, the PF in SFN #8 (SFN #24) is shifted to SFN #2 (SFN #18) based on the second configuration or set of rules.

For example, the 1^{st} configuration rules can determine the PF and PO using the following rules:

$$\begin{matrix}\begin{matrix}SFN for the PF is determined by : \\ ( SFN + PF\_offset ) mod T = ( T / N ) * ( UE\_ID mod N ) ; and\end{matrix} \\ \begin{matrix}Index ( i\_s ) , indicating the index of the PO is determined by : \\ i\_s = floor ( UE\_ID / N ) mod Ns .\end{matrix}\end{matrix}$$

The 2^{nd} configuration rules can determine the PF and PO using the following rules:

$$\begin{matrix}\begin{matrix}SFN for the PF is determined by : \\ ( SFN + PF\_offset ) mod T = ( UE\_ID mod N ) ; and\end{matrix} \\ \begin{matrix}Index ( i\_s ) , indicating the index of the PO is determined by : \\ i\_s = floor ( UE\_ID / N ) mod Ns ,\end{matrix}\end{matrix}$$

where SFN is the system frame number, PF_offset is the offset configured by the gNB to shift the PFs within the duration T, T is the DRX cycle of the UE, UE_ID is the UE identifier, T/N represents the number of PFs within the duration of T, and Ns represents the number of POs within a PF, which can take value of either 1 or 2. This is applicable when SearchSpaceId=0 is configured for pagingSearchSpace. Otherwise, Ns may be 1, 2, or 4.

Other examples of the PF and PO determination rules are:

$$\begin{matrix}\begin{matrix}SFN for the PF is determined by : \\ ( SFN + PF\_offset ) mod T = L * ( UE\_ID mod M ) ; and\end{matrix} \\ \begin{matrix}Index ( i\_s ) , indicating the index of the PO is determined by : \\ i\_s = floor ( UE\_ID / N ) mod Ns ,\end{matrix}\end{matrix}$$

where M is the on-duration in which the gNB is expected to send the paging, and L is the frame gap between consecutive PFs. In the example in FIG. 5, PF_offset=0, T=16, L=2, and M=4.

In one example, 4 PFs may be consecutive and placed within the ON duration in FIG. 5 according to the second configuration or set of rules. In other words, depending on the value of N, the UE may identify the paging frames in a consecutive manner starting from the first frame within the ON duration or at an offset from the first frame within the ON duration.

Alternatively, in another embodiment, Ns may be an integer larger than 4, such as 6, 8, 10, 12, 14, 16 etc. This may be applicable when the network configures fewer PFs within a DRX cycle. Additional values of the number of paging frames within the DRX cycle, value N, may be also supported. For example, N =T/32, T/64, T/128, etc., where T is the DRX cycle. This may be formulated by the following:

$$SFN for the PF is determined by : ( SFN + PF\_offset ) mod T = T / N * ( UE\_ID mod ( N ) ) ;$$

$$Index ( i\_s ) , indicating the index of the PO is determined by : i\_s = floor ( UE\_ID / ( N ) ) mod ( Ns ) ;$$

$$N = T , T / 2 , T / 4 , T / 8 , T / 16 , T / 32 , T / 64 , T / 128 , T / 256 , … ; and$$

$$Ns = 1 , 2 , 4 , 6 , 8 , 10 \; 12 , 14 , 16 , … ,$$

where T is the DRX cycle.

In one example, when Ns>4, the first 4 POs may be used for legacy UEs, whereas later POs are used for Rel-18 UEs. In another example, Rel-18 UEs may use any of the POs depending on configuration, whereas legacy UEs are limited to configuration of the first 4 POs. This may be formulated by the following:

SFN for the PF is determined by:

$$\begin{matrix}\begin{matrix}\begin{matrix}for Rel - 18 UEs , ( SFN + PF\_offset ) mod T = T / N * ( UE\_ID mod ( N ) ) , \\ and\end{matrix} \\ for Rel - 15 / 16 / 17 UEs , ( SFN + PF\_offset )\end{matrix} \\ mod T = T / max ( T / 16 , N ) * ( UE\_ID mod ( max ( T / 16 , N ) ) ) ;\end{matrix}$$

Index (i_s), indicating the index of the PO is determined by:

$$for Rel - 18 UEs , if Ns >= K , i\_s = K + floor ( UE\_ID / ( N ) ) mod ( Ns - K ) , otherwise i\_s = floor ( UE\_ID / ( N ) ) mod Ns , and$$

$$for Rel - 15 / 16 / 17 UEs , i\_s = floor ( UE\_ID / ( N ) ) mod min ( 4 , Ns ) ;$$

$$N = T , T / 2 , T / 4 , T / 8 , T / 16 , T / 32 , T / 64 , T / 128 , T / 256 , … ; and$$

$$Ns = 1 , 2 , 4 , 6 , 8 , 10 \; 12 , 14 , 16 , … ,$$

where T is the DRX cycle, and K is the parameter configured by the gNB or fixed in the specification (e.g., K=4).

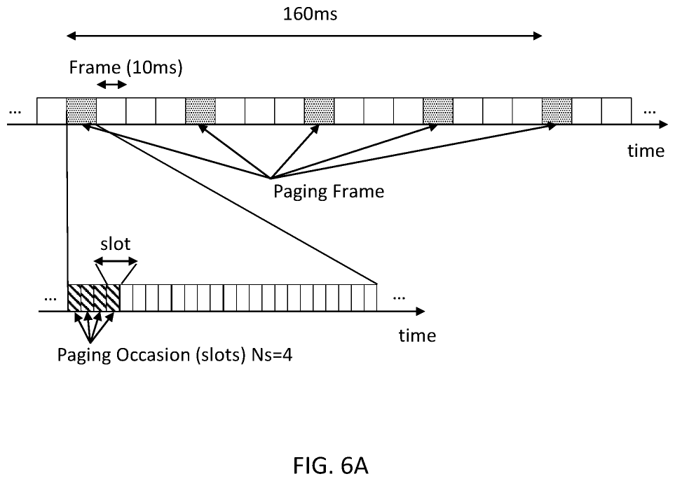

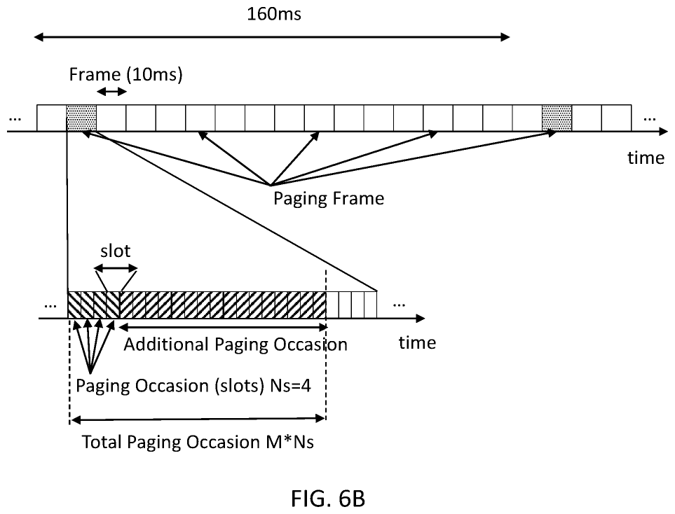

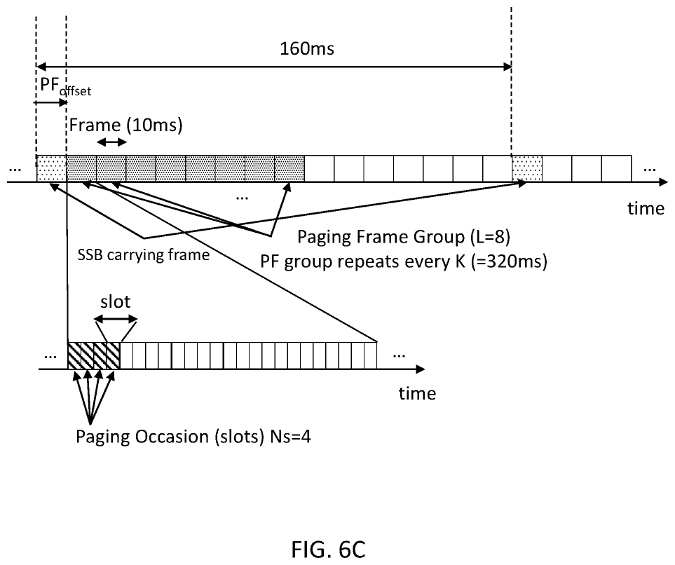

In the example above, PFs and POs are still distributed across the time, and the spacing of the PF may be increased by reducing the overall PF density. FIG. 6A illustrates a paging frame and paging occasion slots in accordance with some embodiments. The paging frame and paging occasion slots shown in FIG. 6A is when N is set to T/4, and Ns is set to 4, and SSB periodicity is set to 160 msec.

In the existing paging frame and paging occasion determination, the gNB may transmit paging every T/N frames, and there are Ns paging occasions. In a 160 msec duration, if N=T/4 and Ns=4, then there are total of 16 paging occasions within 160 msec duration, 4 PO per PF with 4 PF within 160 msec duration.

In another embodiment, the density of the PF within 160 msec may be decreased and the PO per PF proportionally increased. This may be done by introducing a scaling factor, M, to effectively lower the PF density (i.e., increase the PF periodicity) and increase the number of POs. This may be formulated by the one of the following:

$$SFN for the PF is determined by : ( SFN + PF\_offset ) mod T = M * T / N * floor ( U 1 / M ) ; and \qquad Formulation 1 )$$

$$Index ( i\_s ) , indicating the index of the PO is determined by : i\_s = U 2 mod Ns + Ns * ( U 1 mod M ) ,$$

$$where U 1 = UE\_ID mod N , U 2 = floor ( UE\_ID / N ) .$$

$$SFN for the PF is determined by : ( SFN + PF\_offset ) mod T = M * T / N * floor ( U / M ) ; and \qquad Formulation 2 )$$

$$Index ( i\_s ) , indicating the index of the PO is determined by : i\_s = UE\_ID mod ( M * Ns ) ,$$

$$where U = UE\_ID mod N$$

$$SFN for the PF is determined by : ( SFN + PF\_offset ) mod T = M * T / N * ( UE\_ID mod ( N / M ) ) ; and \qquad Formulation 3 )$$

$$Index ( i\_s ) , indicating the index of the PO is determined by : i\_s = floor ( UE\_ID / ( N / M ) ) mod ( M * Ns ) ,$$

where M is the PF reduction and Ns increase factor.

FIG. 6B illustrates reduced paging frame density and increased paging occasion slots in accordance with some embodiments. The reduced paging frame density and increased paging occasion slots shown in FIG. 6B is when M is set to 4, N is set to T/4, and Ns is set to 4. In the example illustration, there are 16 POs within a 160 msec duration, 16 POs per PF with 1 PF per 160 msec. The scaling factor M may change the distribution of the PO without impacting the total of number of POs within a reference time duration or DRX cycle. This potentially allows the gNB to enter lower power states (e.g., sleep modes) for longer periods of time and improves the overall energy efficiency of the network. In other words, in this example, a new configuration or set of rules allows 1 PF to accommodate an increased number of POs, such as larger than 4, compared to legacy paging process in which the number of POs is limited to 4 only. Here, in FIG. 6B, 3 PFs (2^{nd}, 3^{rd}, 4^{th} PFs) are skipped (e.g., it may be equivalent to reduced PF density) and their corresponding POs are grouped with the POs in 1^{st} PF, which now has total of 16 POs. The gNB can configure suitable values of M to realize an increased number of POs; the value of M may be part of the paging configuration provided to the UE.

Another alternative formulation is to support grouped PF allocations with a specific periodicity. Instead of having PFs at regular intervals, L consecutive frames may be provided as a group of PFs and periodic PF groups used. This may be formulated by the one of the following:

$$\begin{matrix}\begin{matrix}\begin{matrix}\begin{matrix}SFN for the PF is determined by : \\ ( SFN + PF\_offset ) mod T = K * floor ( U / L ) + ( U mod L ) , where\end{matrix} \\ U = UE\_ID mod N ; and\end{matrix} \\ Index ( i\_s ) , indicating the index of the PO is determined by :\end{matrix} \\ i\_s = floor ( UE\_ID / N ) mod Ns ,\end{matrix}$$

where, K is periodicity of a PF group (consecutive PFs), and L is the number of consecutive PFs within a PF group (PF group size)

In one example, legacy UEs may monitor POs in only the first PF among the group of L PFs in the above formulation. The remaining L-1 PFs may be used only by Rel-18 UEs. Note that the first PF may also be used by Rel-18 UE, in one option. Spacing between first PFs of the consecutive groups of LP PFs may be T/N, which is K in this example. In other words, eligible PFs where legacy UEs may be mapped are still apart from each other by T/N frames as in the legacy procedure. FIG. 6C illustrates grouped paging frames and paging occasion slots in accordance with some embodiments. The grouped paging frame and paging occasion slots shown in FIG. 6C is with K=32 (PF groups periodicity) and L=8 (number of consecutive PFs within a group) when Nis set to T/4, and Ns is set to 4. Here, in one example, K i.e., PF groups periodicity, may also be same as the DRX cycle length.

It is possible to configure different a PF and PO determining rule set as above to different sets of UEs, and it is possible to configure the same PF and PO determining rule set with different parameters to different sets of UEs.

In one example, the second configuration may include one or more shifts to be applied to one or more monitoring or transmission occasions of the first configuration/rules (i.e., occasions are derived from the first configuration), or may include an explicit indication of configurations related to occasions to arrive at the transmission or reception occasions within the ON duration. Alternatively, the second configuration or set of rules may include identification of one or more shifts to be applied to one or more monitoring or transmission occasions of the first configuration or set of rules or new configuration or set of rules/equations to arrive at the occasions within the ON duration based on one or more of: DTX/DRX cycle periodicity, ON duration, start offset to ON duration, and signal/channel specific parameters from the first configuration/rules, such as: PO and PF related parameters based on first configuration (applicable for PO identification for paging), PDCCH monitoring occasions based on a Type 0 PDCCH common search space (CSS) set, which are determined based on the first configuration or set of rules (cf. TS 38.213, Section 13) (applicable for system information (SI) reception), TRS monitoring occasions (applicable for TRS reception), random access channel (RACH) occasions (RO) related parameters (applicable for physical RACH (PRACH) reception), PEI monitoring occasions related parameters such as permanent equipment identifier (PEI) frame offset to identify the reference frame, symbol offset from reference frame to identify the first MO of PEI etc. (applicable for PEI reception).

In one example, a UE monitors a PDCCH in the Type0-PDCCH CSS set over one or more slots with the Type0-PDCCH CSS set periodicity equal to the periodicity of the SS/PBCH block when the gNB transitions to the DTX/DRX mode. In one example, one or more consecutive slots for PDCCH monitoring with the Type0-PDCCH CSS set may be located after K≥1 slots of SSB transmission within the ON duration. In other words, the PDCCH monitoring window for receiving system information block1 (SIB1) or Remaining Minimum System Information (RMSI) overlap/fall within the ON duration of the DRX/DTX mode at the gNB.

In one embodiment, after the gNB informs the UE(s) of the DTX/DRX mode, there may be an application delay after which the DTX/DRX mode may be assumed to be effective. In one example, the application delay may be configured as part of the DTX/DRX mode or separately configured in the SI or may be fixed by specification.

In one embodiment, the active time when the cell is in the DTX/DRX mode may be extended, such as based on a DRX inactivity timer at the UE operating in the DRX mode. Alternatively, a new inactivity timer may be used associated with the cell DTX/DRX mode, i.e., the active time is observed as long as the inactivity timer, either at the gNB or UE, is running. The inactivity timer or extension of the active time when the cell is in the DTX/DRX mode may be triggered such as by a group-common DCI transmission. This may provide flexibility regarding adjusting the active time in the duty cycle based on loading.

Upon expiry of the inactivity timer, the gNB enters the OFF state. In one example, the gNB may terminate the active time (e.g., inactivity timer). In one example, the active time when the cell is in the DRX/DRX mode may be extended for DRX timers related to a Hybrid Automatic Repeat Request (HARQ) process (e.g., drx-RetransmissionTimerDL, drx-RetransmissionTimerUL, drx-HARQ-RTT-TimerDL, drx-HARQ-RTT-TimerUL) so that the DL/UL HARQ process can complete its data transmissions (i.e., if they are running, the processes continue until the data is transmitted or received). Alternatively, if the DRX timers related to a HARQ process is running, the processes are suspended until the next active time of the gNB or cell DTX/DRX where the processes are then restarted. Yet another alternative is that a new set of DRX timers related to a HARQ process are used associated with the cell DTX/DRX mode. These timers are used when the cell DTX/DRX mode is activated.

In one embodiment, DTX and DRX operation durations may not fully align at the gNB when the gNB is operating based on a duty cycle. For example, in FIG. 3, the ON duration or active time may imply gNB DTX functionality only, whereas reception at the gNB may still continue after ON duration ends. In one example, a new inactivity timer may be introduced that notifies UEs that UL transmissions may be made, e.g., as long as the inactivity timer is running even after the ON duration ends.

In one embodiment, if the gNB signals triggering of the inactivity timer associated with the gNB DTX/DRX duty cycle, this may indicate start of the inactivity timer from a reference point. In one example, the reference point may be different from the start of the slot in which the DCI is provided signaling the trigger. In one option, the reference point may be the start of a frame or a slot, which may be located before or after the trigger signaling is provided. For example, there may be N configured start positions within the ON duration, and the DCI indicates one of the configured start positions for triggering of the inactivity timer. This may alleviate misdetection of the DCI at the UE. In other words, the gNB may send multiple DCIs to notify UEs of the triggering of the inactivity timer, where each DCI may indicate the same start position, ensuring the UEs and gNB are aligned on the assumption of when the inactivity timer is triggered.

In one embodiment, the gNB DTX and DRX mode may be configured with the same configurations or set of rules (e.g., have the same duty cycle and same on-duration period) or may be configured with a different configuration or set of rules. If the configurations are different, the active times (when the gNB is able to transmit or receive) corresponding to the DRX and DTX mode/configurations may or may not overlap. The active time in the DRX (DTX) mode is when the gNB is able to transmit (receive) and the active time may follow a duty cycle. In one example, the DTX and DRX modes may have separate duty cycles running in parallel, where one or more of the ON durations, start offset of ON durations, inactivity timers (which if triggered may prolong the ON duration or active time) corresponding to the gNB DTX and DRX configuration may be configured separately. In one example, the DTX and DRX configurations at the gNB may be separately configured, and the DTX and DRX configurations may or may not be operational at the gNB simultaneously. In one example, the DTX configuration at the gNB may apply as a cell-specific DRX configuration at the UE. Similarly, the DRX configuration at the gNB may apply as cell-specific DTX configuration at the UE, i.e., the UE is only allowed to transmit in the UL when the gNB is active according to a duty cycle based on the DRX configuration at the gNB. To this end, in one example, the gNB may indicate one or more of the following mode/state/configuration(s) at the gNB to the UE:
1. Activate a DTX configuration with a duty cycle
2. Activate a DRX configuration with a duty cycle. If the DTX and DRX configurations include same parameters (e.g., same start time and duration of active time or ON duration in the duty cycle), then one common configuration may be activated.
3. Activate DTX for a given duration. The duration may also be indicated along with activation. There may be an application delay before the DTX becomes operational.
4. Activate DRX for a given duration. The duration may also be indicated along with activation. There may be an application delay before the DRX becomes operational. If both DTX and DRX apply for the duration, then a common indication may be provided.

In one example, one or more the above configurations may be provided to the UE via broadcast signaling, such as SIBx signaling. In one example, the activation of one or more of the above configurations may be provided to the UE by a DCI, such as a group common DCI or broadcast DCI, e.g., a DCI scheduling a SIB.

In one embodiment, when the gNB transitions to the DTX/DRX mode with a duty cycle while a UE is operating in the DRX mode, the UE may cease to operate one or more of the UE autonomous timers related to the DRX operation such as: drx-onDurationTimer, drx-Inactivity Timer, drx-Retransmission TimerDL, drx-Retransmission Timer UL, drx-HARQ-RTT-TimerDL, or drx-HARQ-RTT-TimerUL. The UE may instead follow the configuration of the gNB DTX/DRX duty cycle. In other words, the gNB may indicate a cell-specific DRX configuration to the UE, which may be interpreted as equivalent to the gNB DTX configuration, where the configuration may comprise a predetermined ON or active time duration every duty cycle. Upon indication of the gNB DTX/DRX mode, the UE switches to the cell-specific DRX configuration and assumes the active time is only valid during the ON duration of the duty cycle. The DRX timers, listed above, which are more relevant for UE-specific DRX configurations may not apply when a cell-specific DRX configuration is active for the UE or gNB indicated transition to the DTX/DRX mode.

In one example, during the OFF period of the duty cycle of the DTX or DRX configuration, the UE does not transmit any signal/channels, including one or more of reference signals such as SRS, UL control information in a PUCCH, or UL data in a PUSCH. In one option, the UE may cease or stop counting the timers, such as cg-RetransmissionTimer, or timers are terminated when the OFF period starts. In another option, the UE-operated timers are disabled when the gNB indicates transition to the DTX or DRX configuration at the gNB. In another example, during the OFF period of the gNB DTX configuration, the UE may still transmit signal/channels, including one or more of reference signals such as SRS, UL control information in a PUCCH, or UL data in a PUSCH.

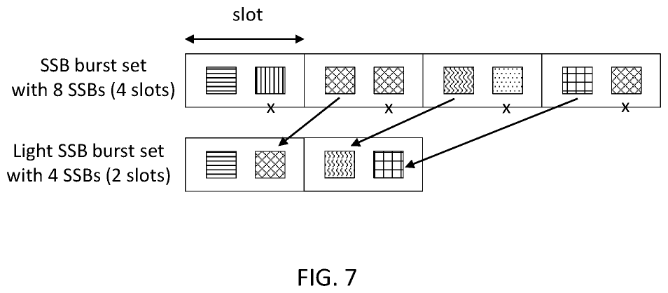

In one embodiment, the gNB may use light SSB transmission to save energy, such as SSB transmission over a limited set of beams. In one example, the burst set comprising light SSB transmission may occupy fewer slots than when SSB transmission for full set of beams are considered. FIG. 7 illustrates light SSB transmission in accordance with some embodiments. The light SSB transmission includes a limited set of SSB transmissions over a shortened duration. In FIG. 7, SSB transmission corresponding to some of the beams are skipped in light SSB transmission, and 4 out of 8 SSB transmissions are made within a compact duration. Switching to light SSB transmission may be indicated by system information or by an existing DCI (e.g., paging DCI, PEI DCI) or dedicated DCI.

In one example, when light SSB transmission is considered, correspondingly one or more PRACH occasions may be skipped and the remaining PRACH occasions associated with the SSB beams in the light SSB may be mapped to resources within a compact duration. Such re-mapping of PRACH occasions may be identified based on a new configuration or set of rules or explicitly configured in system information and used by the UE when the gNB indicates light SSB transmission. Light SSB transmission is also understood to be an example or part of the gNB PSM or DTX/DRX mode.

In one example, light SSB transmission may also include TRS transmission. In one option, such TRS transmission may be activated on s demand basis by system information or DCI signaling.

In one embodiment, PRACH configuration adaptation may be explicitly indicated by a DCI, other than system information. In one example, a dedicated DCI or existing DCI such as a paging DCI or PEI DCI may be leveraged for signaling purposes. In another example, reserved bits in one or more of the existing DCI scheduling system information or paging information may be used for this purpose. A PRACH resource configuration adaptation may include one or more of periodicity adaptation or turning on/off a set of PRACH occasions, among others. In one option, the gNB may send DCI signaling to dynamically adapt association between the SSB and PRACH resources. For example, the DCI may adapt the SSB to PRACH association from one-to-one to many-to-one. This may allow PRACH transmission within a compact window over the PRACH periodicity.

In one embodiment, reconfiguration or remapping of monitoring occasions or transmission occasions can also be adapted for connected mode UEs when the gNB indicates transition to the DTX/DRX mode or PSM. In one example, as discussed above, a new configuration or set of rules may be used to identify valid monitoring or transmission occasions within the gNB ON duration. In an option, a new configuration or re-configuration of PDCCH monitoring occasions in different USS and CSS sets or CSI-RS reception occasions may be used. Similarly in UL, adapting occasions of CG-PUSCH, SRS transmissions etc. may be included. In one example, a configuration may support monitoring or transmitting over a window followed by SSB transmission.

In one embodiment, the gNB may transmit a light SSB or discovery reference signal (DRS) in one or more cells as part of energy saving. Upon detection of the light SSB or DRS, the UE may report to the gNB where the report from one or more UEs may serve as an indication to the gNB to consider full SSB transmission in one or more cells. For idle mode UEs, the reporting may be made via a dedicated channel or by using one or more PRACH resources/occasions where a set of PRACH preambles/resources may be reserved for reporting purposes. In one example, in the PRACH resources or occasions, a separate sequence may also be transmitted instead of PRACH preambles and the gNB may perform hypothesis testing to identify whether received signal is the UE response to the light SSB or DRS or a valid PRACH preamble. Resource identification for the UE response to detection of the light SSB or DRS may be based on SIB signaling or DCI signaling or may be implicitly obtained based on the configuration of the light SSB transmission or DRS transmission. In one example, a DRS may be based on a primary synchronization signal (PSS) or secondary synchronization signal (SSS) or may be a TRS signal configured in idle/inactive mode.

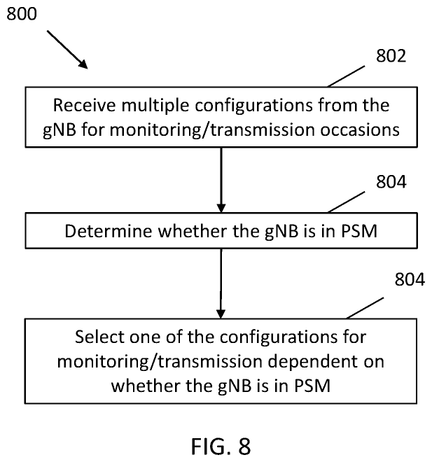

In some embodiments, the electronic devices, networks, systems, chips or components, or portions or implementations thereof, of the above figures may be configured to perform one or more processes, techniques, or methods as described herein, or portions thereof. One such process that may be performed by a UE, one or more elements of a UE, and/or one or more electronic devices that include or implement one or more elements of a UE is depicted in FIG. 8. FIG. 8 illustrates a process of selecting a configuration in accordance with some embodiments. The process 800 may include receiving, at operation 502, multiple configurations from the gNB for monitoring/transmission occasions. The configurations may be received independently or simultaneously. At operation 804, the UE may determine whether the gNB is in PSM based on an indication (such as in a DCI of a PDCCH) from the gNB. At operation 506, the UE may select one of the configurations for monitoring/transmission dependent on whether the gNB is in PSM.

Thus, the gNB may explicitly signal a periodic cell DTX/DRX configuration to UEs connected to the gNB. The gNB may configure a periodic cell DTX/DRX pattern by UE-specific RRC signalling. The cell DTX/DRX configuration contains at least periodicity, start slot/offset, and on duration. The cell DTX/DRX is activated/deactivated implicitly by RRC signalling, i.e., activated immediately once configured by RRC and deactivated once the RRC configuration is released. The UE does not monitor SPS occasions during the cell DTX non-active period; the gNB does not transmit a PDSCH to the UE on the SPS occasions during the cell DTX non-active period, the UE does not transmit on CG occasions during cell DRX non-active periods or SR occasions overlapping with the cell DRX non-active periods or monitor a PDCCH during cell DRX non-active periods. Group common L1 signaling using a PDCCH for cell DTX/DRX activation and deactivation without HARQ feedback is supported.

### EXAMPLES

Example 1 is an apparatus of a user equipment (UE), the apparatus comprising: processing circuitry to configure the UE to: receive, from a 5th generation NodeB (gNB), a first configuration and a second configuration for identification of at least one of monitoring occasions or transmission occasions; determine whether the gNB is in power saving mode (PSM) in which the gNB is in at least one of a discontinuous transmission (DTX) mode or a discontinuous reception (DRX) mode; and select, in idle mode, among the first configuration and the second configuration for at least one of reception or transmission dependent on whether the gNB is in the PSM, the first configuration being selected in response to a determination that the gNB is not in PSM and the second configuration being selected in response to a determination that the gNB is in the PSM; and memory configured to store the first configuration and the second configuration.

In Example 2, the subject matter of Example 1 includes, wherein the processing circuitry configures the UE to receive, from the gNB, an indication that the gNB is transitioning to the PSM.

In Example 3, the subject matter of Example 2 includes, wherein the indication is provided in one of downlink control information (DCI), UE-specific dedicated radio resource control (RRC) signaling, or group-common dedicated RRC signaling.

In Example 4, the subject matter of Examples 1-3 includes, wherein the processing circuitry configures the UE to receive, from the gNB, system information block (SIB) signaling that contains the first configuration and the second configuration.

In Example 5, the subject matter of Examples 1-4 includes, wherein the processing circuitry configures the UE to apply, as the second configuration, a shift towards one or more monitoring or transmission occasions of the first configuration.

In Example 6, the subject matter of Examples 1-5 includes, wherein the PSM is applicable to each cell at the gNB.

In Example 7, the subject matter of Examples 1-6 includes, wherein the processing circuitry configures the UE to use the second configuration to align with at least one of a DTX configuration or a DRX configuration of the gNB, the at least one of the DTX configuration or a DRX configuration including a periodicity, a start slot or offset, and an ON duration.

In Example 8, the subject matter of Examples 1-7 includes, wherein: the PSM includes an operation cycle that includes an active time followed by an inactive period, and the processing circuitry configures the UE in the idle mode to: at least one of monitor or transmit within the active time in response to the determination that the gNB is in the PSM, and skip monitoring or transmission occasions outside of the active time.

In Example 9, the subject matter of Example 8 includes, wherein the processing circuitry configures the UE to: receive downlink control information (DCI), the DCI being a group-common DCI or broadcast DCI; initiate an inactivity timer based on reception of the DCI; and determine that the active time occurs until expiry of the inactivity timer.

In Example 10, the subject matter of Examples 8-9 includes, wherein the processing circuitry configures the UE to one of: extend the active time based on at least one of a DTX timer or DRX timer related to a Hybrid Automatic Repeat Request (HARQ) process to permit completion of data transmissions related to the HARQ process; or at an end of the active time, suspend at least one of the DTX timer or DRX timer until a next active time.

In Example 11, the subject matter of Examples 8-10 includes, wherein the processing circuitry configures the UE to: receive downlink control information (DCI) that indicates a reference point that is independent of a start of a slot in which the DCI is provided or multiple DCIs that each indicates an identical start position among a plurality of configured start positions within the active time; initiate an inactivity timer from the reference point based on reception of the DCI; and determine that the active time occurs until expiry of the inactivity timer.

In Example 12, the subject matter of Examples 1-11 includes, wherein: the processing circuitry configures the UE to determine at least one parameter of the DTX mode and DRX mode of the gNB, the at least one parameter of the DTX mode is independent of the at least one parameter of the DRX mode, and the at least one parameter is selected from a group of parameters that include a duty cycle, a start offset of an ON duration, and an inactivity timer.

In Example 13, the subject matter of Examples 1-12 includes, wherein the processing circuitry configures the UE to determine: activation at the gNB of at least one of the DTX or DRX mode with a duty cycle or for a predetermined duration, and for activation of the DTX or DRX mode, an application delay before the at least one of the DTX or DRX mode becomes operational.

In Example 14, the subject matter of Examples 1-13 includes, wherein the processing circuitry configures the UE to: determine that the gNB has transitioned to the at least one of the DTX mode or DRX mode with a duty cycle while the UE is operating in a UE DRX mode; and in response to a determination that the gNB has transitioned to at least one of the DTX mode or DRX mode while the UE is operating in the UE DRX mode, terminate operation of at least one or more UE autonomous timers related to DRX operation and instead follow the duty cycle to operate during an ON duration of the duty cycle.

In Example 15, the subject matter of Example 14 includes, wherein the processing circuitry configures the UE to terminate timers at a start of an OFF period of the duty cycle or at a time at which an indication of a transition to DTX or DRX configuration at the gNB is indicated.

In Example 16, the subject matter of Examples 1-15 includes, wherein the processing circuitry configures the UE to: determine, based on the determination that the gNB is in the PSM, that the gNB is using light synchronization system block (SSB) transmission over a limited set of beams in which an SSB burst set occupies fewer slots than occupied by SSB transmission for full set of beams; and determine that the gNB is to skip one or more physical random access channel (PRACH) occasions and PRACH occasions associated with SSB beams in the light SSB are mapped to resources within a compact duration, re-mapping of the PRACH occasions identified based on a new set of rules or explicitly configured in system information or downlink control information (DCI).

Example 17 is an apparatus of a 5th generation NodeB (gNB), the apparatus comprising: processing circuitry to configure the gNB to: send, to a user equipment (UE), a first configuration and a second configuration for identification of at least one of monitoring occasions or transmission occasions; send, to the UE, an indication that the gNB is transitioning to power saving mode (PSM) in which the gNB is in at least one of a discontinuous transmission (DTX) mode or a discontinuous reception (DRX) mode; and at least one of transmit or receive using the first configuration for use when the gNB is not in the PSM and the second configuration when the gNB is in the PSM; and memory configured to store the first configuration and the second configuration.

In Example 18, the subject matter of Example 17 includes, wherein: the PSM includes an operation cycle that includes an active time followed by an inactive period, the at least one of transmission or reception occurs within the active time, and the processing circuitry configures the gNB to transmit, to the UE, downlink control information (DCI) to initiate an inactivity timer, the active time occurring until expiry of the inactivity timer.

Example 19 is a non-transitory computer-readable storage medium that stores instructions for execution by one or more processors of a user equipment (UE), the one or more processors to configure the UE to, when the instructions are executed: receive, from a 5th generation NodeB (gNB), a first configuration and a second configuration for identification of at least one of monitoring occasions or transmission occasions; determine whether the gNB is in power saving mode (PSM) in which the gNB is in at least one of a discontinuous transmission (DTX) mode or a discontinuous reception (DRX) mode; and select, in idle mode, among the first configuration and the second configuration for at least one of reception or transmission dependent on whether the gNB is in the PSM, the first configuration being selected in response to a determination that the gNB is not in PSM and the second configuration being selected in response to a determination that the gNB is in the PSM.

In Example 20, the subject matter of Example 19 includes, wherein the instructions, when executed, configure the one or more processors to receive, from the gNB: one of downlink control information (DCI), UE-specific dedicated radio resource control (RRC) signaling, or group-common dedicated RRC signaling that contains an indication that the gNB is transitioning to the PSM, the PSM including an operation cycle that includes an active time followed by an inactive period; at least one of monitor or transmit within the active time in response to the determination that the gNB is in the PSM, and skip monitoring or transmission occasions outside of the active time; initiate an inactivity timer based on reception of the DCI; and determine that the active time occurs until expiry of the inactivity timer.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An apparatus of a user equipment (UE), the apparatus comprising:
processing circuitry to configure the UE to:
receive, from a 5^{th} generation NodeB (gNB), a first configuration and a second configuration for identification of at least one of monitoring occasions or transmission occasions;
determine whether the gNB is in power saving mode (PSM) in which the gNB is in at least one of a discontinuous transmission (DTX) mode or a discontinuous reception (DRX) mode; and
select, in idle mode, among the first configuration and the second configuration for at least one of reception or transmission dependent on whether the gNB is in the PSM, the first configuration being selected in response to a determination that the gNB is not in PSM and the second configuration being selected in response to a determination that the gNB is in the PSM; and
memory configured to store the first configuration and the second configuration.

2. The apparatus of claim 1, wherein the processing circuitry configures the UE to receive, from the gNB, an indication that the gNB is transitioning to the PSM.

3. The apparatus of claim 2, wherein the indication is provided in one of downlink control information (DCI), UE-specific dedicated radio resource control (RRC) signaling, or group-common dedicated RRC signaling.

4. The apparatus of claim 1, wherein the processing circuitry configures the UE to receive, from the gNB, system information block (SIB) signaling that contains the first configuration and the second configuration.

5. The apparatus of claim 1, wherein the processing circuitry configures the UE to apply, as the second configuration, a shift towards one or more monitoring or transmission occasions of the first configuration.

6. The apparatus of claim 1, wherein the PSM is applicable to each cell at the gNB.

7. The apparatus of claim 1, wherein the processing circuitry configures the UE to use the second configuration to align with at least one of a DTX configuration or a DRX configuration of the gNB, the at least one of the DTX configuration or a DRX configuration including a periodicity, a start slot or offset, and an ON duration.

8. The apparatus of claim 1, wherein:
the PSM includes an operation cycle that includes an active time followed by an inactive period, and
the processing circuitry configures the UE in the idle mode to:
at least one of monitor or transmit within the active time in response to the determination that the gNB is in the PSM, and
skip monitoring or transmission occasions outside of the active time.

9. The apparatus of claim 8, wherein the processing circuitry configures the UE to:
receive downlink control information (DCI), the DCI being a group-common DCI or broadcast DCI;
initiate an inactivity timer based on reception of the DCI; and
determine that the active time occurs until expiry of the inactivity timer.

10. The apparatus of claim 8, wherein the processing circuitry configures the UE to one of:
extend the active time based on at least one of a DTX timer or DRX timer related to a Hybrid Automatic Repeat Request (HARQ) process to permit completion of data transmissions related to the HARQ process; or
at an end of the active time, suspend at least one of the DTX timer or DRX timer until a next active time.

11. The apparatus of claim 8, wherein the processing circuitry configures the UE to:
receive downlink control information (DCI) that indicates a reference point that is independent of a start of a slot in which the DCI is provided or multiple DCIs that each indicates an identical start position among a plurality of configured start positions within the active time;
initiate an inactivity timer from the reference point based on reception of the DCI; and
determine that the active time occurs until expiry of the inactivity timer.

12. The apparatus of claim 1, wherein:
the processing circuitry configures the UE to determine at least one parameter of the DTX mode and DRX mode of the gNB,
the at least one parameter of the DTX mode is independent of the at least one parameter of the DRX mode, and
the at least one parameter is selected from a group of parameters that include a duty cycle, a start offset of an ON duration, and an inactivity timer.

13. The apparatus of claim 1, wherein the processing circuitry configures the UE to determine:
activation at the gNB of at least one of the DTX or DRX mode with a duty cycle or for a predetermined duration, and
for activation of the DTX or DRX mode, an application delay before the at least one of the DTX or DRX mode becomes operational.

14. The apparatus of claim 1, wherein the processing circuitry configures the UE to:
determine that the gNB has transitioned to the at least one of the DTX mode or DRX mode with a duty cycle while the UE is operating in a UE DRX mode; and
in response to a determination that the gNB has transitioned to at least one of the DTX mode or DRX mode while the UE is operating in the UE DRX mode, terminate operation of at least one or more UE autonomous timers related to DRX operation and instead follow the duty cycle to operate during an ON duration of the duty cycle.

15. The apparatus of claim 14, wherein the processing circuitry configures the UE to terminate timers at a start of an OFF period of the duty cycle or at a time at which an indication of a transition to DTX or DRX configuration at the gNB is indicated.

16. The apparatus of claim 1, wherein the processing circuitry configures the UE to:
determine, based on the determination that the gNB is in the PSM, that the gNB is using a light synchronization system block (SSB) transmission over a limited set of beams in which an SSB burst set occupies fewer slots than occupied by an SSB transmission for full set of beams; and
determine that the gNB is to skip one or more physical random access channel (PRACH) occasions and PRACH occasions associated with SSB beams in the light SSB transmission are mapped to resources within a compact duration, re-mapping of the PRACH occasions identified based on a new set of rules or explicitly configured in system information or downlink control information (DCI).

17. An apparatus of a 5^{th} generation NodeB (gNB), the apparatus comprising:
processing circuitry to configure the gNB to:
send, to a user equipment (UE), a first configuration and a second configuration for identification of at least one of monitoring occasions or transmission occasions;
send, to the UE, an indication that the gNB is transitioning to power saving mode (PSM) in which the gNB is in at least one of a discontinuous transmission (DTX) mode or a discontinuous reception (DRX) mode; and
at least one of transmit or receive using the first configuration for use when the gNB is not in the PSM and the second configuration when the gNB is in the PSM; and
memory configured to store the first configuration and the second configuration.

18. The apparatus of claim 17, wherein:
the PSM includes an operation cycle that includes an active time followed by an inactive period,
the at least one of transmission or reception occurs within the active time, and
the processing circuitry configures the gNB to transmit, to the UE, downlink control information (DCI) to initiate an inactivity timer, the active time occurring until expiry of the inactivity timer.

19. A non-transitory computer-readable storage medium that stores instructions for execution by one or more processors of a user equipment (UE), the one or more processors configure the ^{UE} to, when the instructions are executed:
receive, from a 5th generation NodeB (gNB), a first configuration and a second configuration for identification of at least one of monitoring occasions or transmission occasions;
determine whether the gNB is in power saving mode (PSM) in which the gNB is in at least one of a discontinuous transmission (DTX) mode or a discontinuous reception (DRX) mode; and
select, in idle mode, among the first configuration and the second configuration for at least one of reception or transmission dependent on whether the gNB is in the PSM, the first configuration being selected in response to a determination that the gNB is not in PSM and the second configuration being selected in response to a determination that the gNB is in the PSM.

20. The non-transitory computer-readable storage medium of claim 19, wherein the one or more processors, when the instructions are executed, configure the UE to receive, from the gNB:
one of downlink control information (DCI), UE-specific dedicated radio resource control (RRC) signaling, or group-common dedicated RRC signaling that contains an indication that the gNB is transitioning to the PSM, the PSM including an operation cycle that includes an active time followed by an inactive period;
at least one of monitor or transmit within the active time in response to the determination that the gNB is in the PSM, and skip monitoring or transmission occasions outside of the active time;
initiate an inactivity timer based on reception of the DCI; and
determine that the active time occurs until expiry of the inactivity timer.
